(19) United States
(12) Patent Application Publication
(10) Pub. No.: US 2024/0331044 A1
(43) Pub. Date: Oct. 3, 2024

(54) SYSTEM FOR PROVIDING A PROPERTY MANAGEMENT AND REAL ESTATE INVESTMENT PLATFORM

(71) Applicant: Tyler Casey, Pittsburg, KS (US)

(72) Inventor: Tyler Casey, Pittsburg, KS (US)

(21) Appl. No.: 18/218,901

(22) Filed: Jul. 6, 2023

Related U.S. Application Data
(60) Provisional application No. 63/358,628, filed on Jul. 6, 2022.

(51) Int. Cl. G06Q 40/06; G06Q 50/163

(52) U.S. Cl. CPC G06Q 40/06; G06Q 50/163

(57) ABSTRACT

A system for providing a property management and real estate investing platform is disclosed, including at least one device in operable connection with a network. An application server is in operable communication with the network to host an application system displaying property management and real estate investing information. The application system includes a user interface module for providing access to the application system to the at least one device. The user interface permits the user to interact with a communication module to receive information related to a property, wherein the communication module transmits alerts to and from the user. A checklist module generates one or more checklists and transmitting the one or more checklists to a user. A payment processing module permits the transmission of funds between a first user and a second user.

### TECHNICAL FIELD

The embodiments generally relate to computerized systems for providing a property management and real estate investment platform.

### BACKGROUND

Property management processes are notoriously laborious and complicated. For example, property management requires the property manager to oversee and coordinate upkeep and maintenance of the facility, manage payments received from tenants, market the property when units are available for lease, perform inspections, etc. Historically, these processes have been performed manually by a property manager or management team and have required multiple software solutions each specific to one aspect of property management. Similarly, real estate investment, market analysis, and the various processes needed to execute an investment transaction and maintain an investment are notoriously difficult to navigate.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments include a system for providing a property management and real estate investing platform. The system includes at least one device in operable connection with a network. An application server is in operable communication with the network to host an application system displaying property management and real estate investing information. The application system includes a user interface module for providing access to the application system to the at least one device. The user interface permits the user to interact with a communication module to receive information related to a property, wherein the communication module transmits alerts to and from the user.

The system can be used by tenants, property managers, property owners, real estate investors, franchisees, vendors, staff, and the like. The system simplifies the property management and real estate investment processes, makes each process automated and more efficient, and reduces the likelihood for human error. The system completely eliminates the need for human administrative input. It will do everything from managing the transaction process automatically based only on customer/consumer input, meaning drafting contracts, ordering inspections, ordering title work etc., to managing work order assignment and completion for repairs with no administrative input required, to automating the collections process including evictions and automatic legal document filing.

In one aspect, the system automatically alerts team members and prospective tenants who has an approved application of the process and timeline required to complete the transaction. Lease execution, rent and deposit payment occur simultaneously within the system.

In one aspect, a checklist module generates one or more checklists and transmitting the one or more checklists to a user. Digitized checklists are integrated, and automated notifications are sent to team members when an action is required of them in the predetermined timeline.

In one aspect, a payment processing module permits the transmission of funds between a first user and a second user. Bills may be automated and scheduled to provide increased efficiency.

In one aspect, a work order module generates and transmit a work order. The work order module may provide a timeline input by a user from when work order is received to when it should be accepted or denied/completed.

In one aspect, a market analysis module analyzes a market and transmit market analysis information to the user.

In one aspect, a key generator generates a digital key and transmit the digital key to the user. The key generator may provide a barcode and/or QR code scanning features to allow for efficient check-in and check-out to a property. The key generator provides an efficient means for tracking keys and managing their capabilities based on the user they are assigned to.

In one aspect, a forms module generates, transmits, and analyzes at least one form.

In one aspect, a task module is in communication with the checklist module, the task module to manage one or more tasks.

In one aspect, a training module to provides a training platform to the user.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments; and

FIG. 2 illustrates a block diagram of a computing system and an application program, according to some embodiments.

FIG. 3 illustrates a block diagram of a property management and investing process, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the systems and methods described herein relate to a system for providing a property management and real estate investment platform which can be used by tenants, property managers, property owners, real estate investors, franchisees, vendors, staff, and the like. The system simplifies the property management and real estate investment processes, makes each process automated and more efficient, and reduces the likelihood for human error. The system completely eliminates the need for human administrative input. It will do everything from managing the transaction process automatically based only on customer/consumer input, meaning
drafting contracts, ordering inspections, ordering title work, etc., to managing work order assignment and completion for repairs with no administrative input required, to automating the collections process including evictions and automatic legal document filing. The system manages automatic key management through QR code integration with smart phones and key kiosks. It also acts as a franchisor reporting function. The system tracks key performance indicators (KPIs) on vendors, employees, franchise operators etc. and assigning them a rating.

In some embodiments, the system provides scan in and scan out key management functionality with ability to remotely access keys.

In some embodiments, the system provides direct consumer-to-consumer real estate transfer with entire process happening automatically based on consumer input into the system alone.

In some embodiments, the system provides interaction-less home leasing, approval/application process, work order fulfillment to aid in increasing efficiency and convenience of the platform.

As used herein, the term “user” may be utilized to relate to any user of the system including property owners, property managers, tenants, vendors, franchisees, administrative users, staff, and the like.

In some embodiments, the property management and real estate investment platform provides various status alerts to the users including eviction status, payment status, statement access and manipulation, and the like. Automated alerts may be transmitted via text message, voice message, mail, etc. to alert the tenant or property manager of upcoming billing, evictions
status, changes to their account and statements, and the like. Alerts may be accompanied by follow-up reminders at predetermined time intervals.

In some embodiments, the system permits forms (i.e., paperwork in the form of electronic documents) to be easily uploaded. The system may automatically analyze, and parse content contained on the forms.

In some embodiments, the system automates work orders. When the tenants input a work order, it automatically sends out videos to tenant to manage expectation let them know were working on the back end give them trouble shooting options. The system may automatically send work orders and follow up with vendors to insure they're being accepted denied. The system may transmit alerts to follows up on completion via text message to tenant and vendor. In some embodiments, the vendor is required to upload photos of completed repair and invoice prior to payment. The system may automatically pay this bill once all parties, including tenant has responded back that repair was completed satisfactorily. System should “check in” until a response is received from all parties.

In some embodiments, the system may automate collections to send tenants predetermined messages on predetermined dates without human interaction. Even send notifications to owners to either approve or deny eviction proceeding at a predetermined date. Then automate sending proper legal notices to tenants. System should automatically initiate the appropriate process servers to deliver eviction notices.

From the tenant perspective, the tenant will click on “find my home” which will lead them to a series of listings with high quality photos and video walk throughs of all available properties in whatever market they're searching in. In some cases, the tenant may select a property, click
“apply” and input information to begin the application process. The system's algorithm may then scour the web for their background, credit history, evictions, bankruptcies, income etc. and approve them in the platform. In some embodiments, the system's algorithm connects the system to one or more electronic background checking services or systems and/or one or more electronic credit checking services or systems. Once approved, the tenant could click “sign lease” and the system automatically generates the appropriate lease for the state and property with the appropriate terms.

In some embodiments, the system launches a video to welcome the tenant to the platform and explains the next steps for completing a lease agreement. The app would then at the conclusion of this video issue their digital key directly through their phone which they could save on their Home Screen or their Apple wallet or Google wallet or similar electronic wallet. This allows the tenant to access their home or apartment anytime their phone is placed in front of digital keypad using, for example RF (radio frequency) technologies, NFC (near field communication) technologies, QR codes, Bluetooth®, a proprietary communication protocol, and/or the like. This key is unique, and they can only digitally send temporary copies, or as many permanent copies as the lease allows to the appropriate people. The system tracks which users received these keys, whose key was used to enter at what time, etc. The tracking feature extends to one day temporary codes for vendors, visitors, etc. Once they've been issued their key automatically, algorithmically, they would get a series of prompts to fill out a digital form regarding the condition upon move in and submit this.

In some embodiments, each functionality of the system may be using an artificial intelligence enabled avatar to assist the user throughout the above processes.

From the property owner perspective, similar efficient capabilities are provided. In the case where the property owner want to execute a new purchase, the system may provide virtual tours, walk-throughs, and other resources. The system may provide market analysis, work needed, work and repairs status, repair costs, etc., to aid in the property owner's investment decisions based on various market and property factors. The property owner may be able to efficiently submit an offer, sign a contract, etc. The system may also help the property owner find suitable tenants for their property.

Property managers may utilize the platform to interface with the various features of the system including access to the automated technologies, marketing materials, best practices, forms etc. Education and training may eventually be provided remotely using VR with a virtual property professor or other trainer.

The system provides a platform for automating real estate processes and investment processes. This may include processes for inputting banking information as part of the application process an algorithm could also be used to get them an automatic prequalify from one of our banking partners. Contracts may be automatically generated from the input given by customers, bankers, title companies and attorneys. The system may provide a list of task which need to be conducted, such as inspections or appraisals.

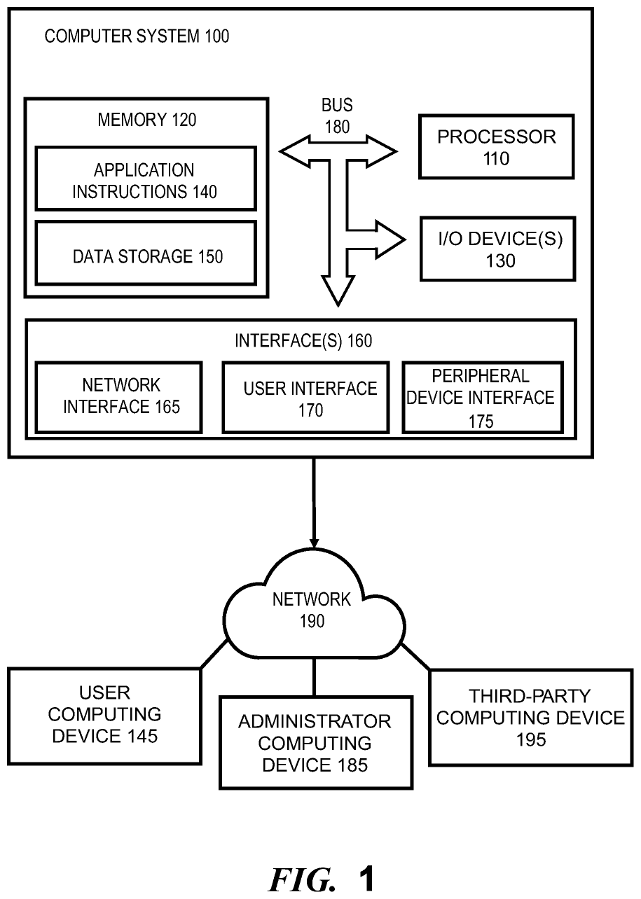

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry

Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading
execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile
memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic
waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor
110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's
computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via
wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote
source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server
executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the various property management and real estate investment functionalities of the system. The third-party computing device 195 may be utilized by third parties to receive communications from the user computing device and/or administrative computing device 185. In one example, a third-party may be a franchisee.

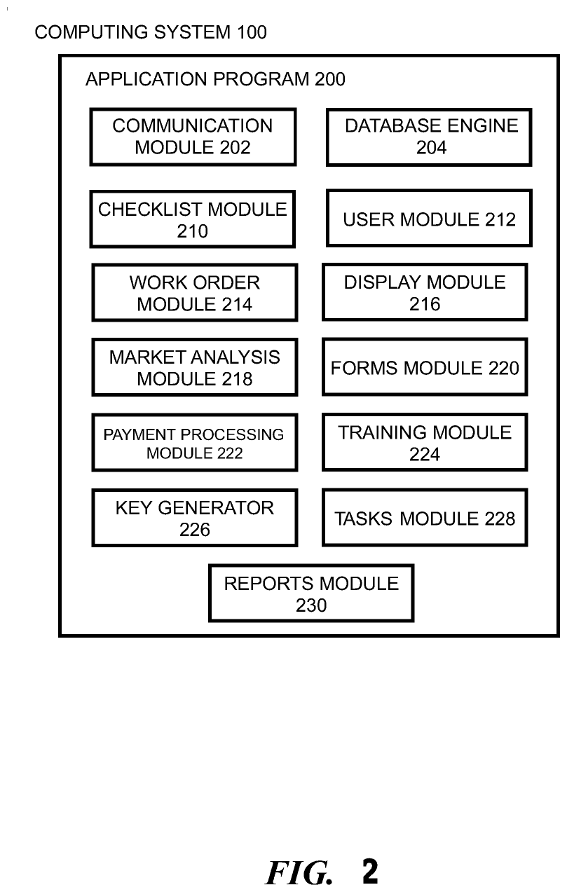

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a checklist module 210, a user module 212, a work order module 214, a display module 216, market analysis module 218, a forms module 220, a payment processing module 222, a training module 224, a key generator 226, a tasks module 228, and a reports module 230.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

The communication module 202 is operable to transmit alerts as described hereinabove.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the checklist module 210 is configured to provide various checklists including but not limited to new owner checklists, new tenant checklists, new property checklists,
move-out checklists, and the like. Checklists will be set up with lists of tasks the user will need to complete. The checklists will be set up to where a user (for example, a property manager or a tenant or an employee) cannot move forward on a checklist if they or another user does not complete a step. If the user is waiting on an item from another user or users (for example, waiting for a tenant, vendor and/or property owner to complete a step), they will have the ability to send a notification to the other user or users to request the item using the task feature. For checklists that have a user wait for another user or users as part of the checklist process, the system may automatically notify such other user or users without any input requirements.

In some embodiments, the user module 212 facilitates the creation of a user account for the application system. The user module 212 may allow the user to input account information, user preferences, and the like.

In some embodiments, the work order module 214 is configured to generate and permit users to submit work orders for various tasks associated with a property. If a work order is denied, the tenant would get a note as to why the work order is denied. When a work order is submitted it goes to the staff member for the franchisee for them to select the vendor from their list of vendors to receive the work order. The vendor will have a certain amount of time to accept the work order. If the vendor does not accept the work order in the required amount of time, the work order will be sent to the next vendor on the preferred vendor list. When a vendor accepts the work order, they will have the ability to message directly with the user that submitted the work order to get the work scheduled and discuss additional details.

After the work has been completed, the vendor would have the ability to upload any invoices, pictures or documentation pertaining to the work order. When information is uploaded by the vendor, the user that submitted the work order would receive a notification and have the ability to either approve or deny that the work has been to a satisfactory level. If the work order is approved, the tenant, vendor, property owner, and the user will be notified.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the display module 216 may be in communication with an AI engine to provide an AI avatar to direct users through various aspects of the platform.

In some embodiments, the market analysis module 218 is configured to analyze market conditions to educate the user of the risks surrounding an investment decision.

In some embodiments, the forms module 220 is configured to generate, transmit, and interpret forms. The system may generate forms to be filled by a user of the system. Information input into the form will be interpreted and parsed as needed.

In some embodiments, the payment processing module 222 is configured to permit users to set up payments on autopay to reoccur at the appropriate time. When the payment method listed on their user profile is charged, the user will receive a notification informing them of the transaction. Payments may be processed using various processes known in the arts.

In some embodiments, the training module 224 is configured to permit users to view training materials and processes within the system.

In some embodiments, the key generator module 226 is configured to generate digital keys and transmit the digital keys to one or more users of the system. The digital keys may be single-use or multi-use based on the users' credentials and user role(s).

In some embodiments, the tasks module 228 is configured to permit users to create and/or assign tasks to any user of the system.

In some embodiments, the reports module 230 is configured to permit access and interaction with various reports. Reports may include ledger reports, owner reports, statements, internal reports, and franchise level reporting.

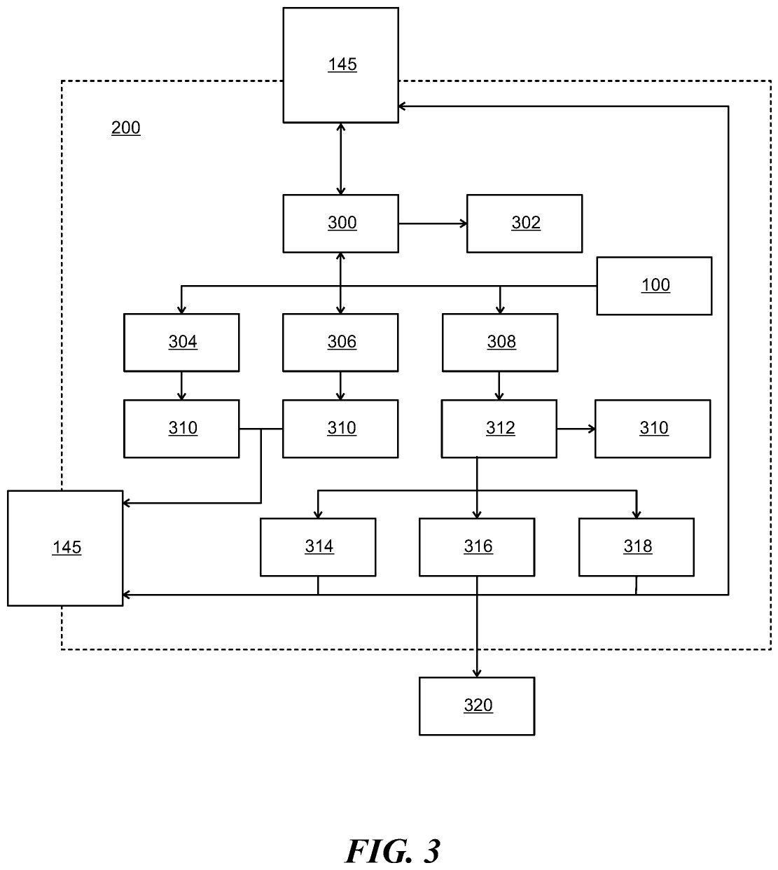

FIG. 3 illustrates a processes executable by and/or in the computer system 100. In some embodiments, the process is executable by a processor executing the application instructions 140 and/or the application program 200. In some embodiments, a computer readable media or medium has readable instructions executable by a processor which, when executed, performs the process. It will be apparent to those with ordinary skill in the art which types of users and/or the role of the user devices 145 accessing the computer system 100 and/or executing the application instructions 140 or part of the application instructions 140 or the application program 200 or part of the application program 200.

FIG. 3 illustrates a property management and investing process 300. The process 300 starts at step 310, where a server or computer, such as computer system 100, hosts a property management and real estate investing application such as application program 200. Next, on step 315, a user device, such as user computing device 145, is provided access to the hosted application. Then, on step 320, a first user is permitted to interact with a communication module, such as communication module 202, to receive information related to a property.

When appropriate, the process 300 moves on to step 325, where the hosted application causes the transmission of alerts to and from the first user based on the information related to the property, as discussed above.

When appropriate, the process 300 moves on to step 330, where the hosted application causes the generation of one or more checklists, as discussed above. Next, on step 335, the hosted application transmits at least one of the one or more checklists to the first user or to a second user. For example, if the first user may be a property owner or manager, inputting information about a property. Alternatively, the first user might be a potential tenant that had questions about a property, the hosted application capturing the questions, generating a checklist based on the questions or information from the first user, and transmitting the checklist to the second user, a property manager.

When appropriate, the process 300 moves on to step 340, where the hosted application enables the transmission of funds between the first user and the second user. For example, the second user might be a tenant that needs to pay rent to the first user. The hosted application would enable either manual or automatic payment of rent based on roles and preferences, such as preferences of whether to pay manually or automatically, method of payment, and/or the like.

When appropriate, the process 300 moves on to step 345, where the hosted application generates a work order as discussed above.

When appropriate, the process 300 moves on to step 350, where the hosted application analyzes a market and transmits the market analysis information to the first user, the second user, or to one of the users of a plurality of users, as discussed above.

When appropriate, the process 300 moves on to step 355, where the hosted application, via a key generator, generates a digital key and transmits the digital key to the first user, the second user, and/or to a user of the plurality of users, based on the role of the user and the reasons for the request of the digital key. The type of digital key (permanent, temporary, one-time use, disabled etc.) will depend on the role of the user and the circumstances surrounding the requested and/or the required access, as discussed above.

When appropriate, the process 300 moves on to step 360, where the hosted application generates, transmits, and analyzes a form, as discussed above.

When appropriate, the process 300 moves on to step 365, where the hosted application, via a task module, manages one or more tasks, as discussed above.

When appropriate, the process 300 moves on to step 370, where the hosted application, via a training module, provides training to a user of the plurality of users, as discussed above.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination
with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local
system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer
operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing a property management and real estate investing platform, the system comprising:
at least one device in operable connection with a network;
an application server in operable communication with the network, the application server configured to host an application system displaying property management and real estate investing information, the application system having a user interface module for providing access to the application system to the at least one device, the user interface to permit the user to interact with a communication module to receive information related to a property, wherein the communication module transmits alerts to and from the user;
a checklist module for generating one or more checklists and transmitting the one or more checklists to a user; and
a payment processing module to permit the transmission of funds between a first user and a second user.

2. The system of claim 1, further comprising work order module to generate and transmit a work order.

3. The system of claim 1, further comprising a market analysis module to analyze a market and transmit market analysis information to the user.

4. The system of claim 1, further comprising a key generator to generate a digital key and transmit the digital key to the user.

5. The system of claim 1, further comprising a forms module to generate, transmit, and analyze at least one form.

6. The system of claim 1, further comprising a task module in communication with the checklist module, the task module to manage one or more tasks.

7. The system of claim 1, further comprising a training module to provide a training platform to the user.

8. A computer readable medium having computer readable instructions executable by a processor which, when executed, performs a process for property management and real estate investing, the process comprising:
hosting an application system displaying property management and real estate investing information;
providing access to the application system to at least one device;
permitting a first user to interact with a communication module to receive information related to a property, wherein the communication module transmits alerts to and from the first user;
generating one or more checklists and transmitting the one or more checklists to a second user; and
transmitting funds between the first user and a second user.

9. The computer readable medium of claim 8, the process further comprising generating and transmitting a work order.

10. The computer readable medium of claim 8, the process further comprising analyzing a market and transmitting market analysis information to the first user.

11. The computer readable medium of claim 8, the process further comprising generating a digital key and transmitting the digital key to the second user.

12. The computer readable medium of claim 8, the process further comprising generating, transmitting, and analyzing at least one form.

13. The computer readable medium of claim 8, the process further comprising managing one or more tasks.

14. A property management and real estate investing process, the process comprising:
hosting an application system displaying property management and real estate investing information;
providing access to the application system to at least one device;
permitting a first user to interact with a communication module to receive information related to a property, wherein the communication module transmits alerts to and from the first user;
generating one or more checklists and transmitting the one or more checklists to a second user; and
transmitting funds between the first user and a second user.

15. The process of claim 15, the process further comprising generating and transmitting a work order.

16. The process of claim 15, the process further comprising analyzing a market and transmitting market analysis information to the first user.

17. The process of claim 15, the process further comprising generating a digital key and transmitting the digital key to the second user.

18. The process of claim 15, the process further comprising generating, transmitting, and analyzing at least one form.

19. The process of claim 15, the process further comprising managing one or more tasks.

20. The process of claim 15, the process further comprising providing a training platform to the user.
